(19) United States
(12) Patent Application Publication
(10) Pub. No.: US 2014/0344896 A1
(43) Pub. Date: Nov. 20, 2014

(54) METHOD AND APPARATUS FOR USING ELECTRONIC DEVICE

(71) Applicant: Samsung Electronics Co., Ltd., Suwon-si (KR)

(72) Inventors: Michael Chin-Hwan PAK, Hwaseong-si (KR); Ji-Hwan SONG, Seongnam-si (KR); Il-Woong JEONG, Suwon-si (KR); Chang-Taek KANG, Suwon-si (KR); Yo-Hwa KIM, Yongin-si (KR); Ju-Ha PARK, Yongin-si (KR); Ga-Jin SONG, Anyang-si (KR); Eui-Chang JUNG, Seoul (KR)

(73) Assignee: Samsung Electronics Co., Ltd., Suwon-si (KR)

(21) Appl. No.: 14/281,002

(22) Filed: May 19, 2014

(30) Foreign Application Priority Data
May 20, 2013 (KR) 10-2013-0056773

(51) Int. Cl. G06F 21/45

(52) U.S. Cl. CPC G06F 21/45; G06F 2221/2141
USPC 726/4

(57) ABSTRACT

A method of using an electronic device is provided. The method includes comparing, when a request for an access to a resource of the electronic device is identified, a reliability level of a user and a security level of the resource and permitting the access to the resource when the reliability level is equal to or higher than the security level of the resource.

### CROSS-REFERENCE TO RELATED APPLICATION(S)

This application claims the benefit under 35 U.S.C. §119(a) of a Korean patent application filed on May 20, 2013 in the Korean Intellectual Property Office and assigned Serial number 10-2013-0056773, the entire disclosure of which is hereby incorporated by reference.

### TECHNICAL FIELD

The present disclosure relates to an electronic device. More particularly, the present disclosure relates to controlling the use of resources according to a reliability level of a user when the resources of an electronic device such as an application or a file are used in the electronic device.

### BACKGROUND

The use of an electronic device such as a smart phone or a tablet Personal Computer (PC) has been generalized. The electronic device requires protecting personal information of users such as a contact number, a message transmission/reception history, and the like, and accordingly has had various authentication methods.

For example, there are an authentication method of inputting a preset password, an authentication method of inputting a preset pattern, an authentication method of using an accredited certificate, and an authentication method of using a fingerprint verification.

Applications (for example, a final payment application and the like) requiring a separate additional authentication may be installed in the electronic device. Further, a user may activate a security setting of predetermined data among data stored in the electronic device and set the electronic device such that an access to the corresponding data is possible only through a separate authentication. However, so many authentications make use of the electronic device inconvenient for the user. Accordingly, there is a need for an improved apparatus and method for minimizing an authentication to use resources of the electronic device and enhance security of the electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for minimizing an authentication to use resources of the electronic device and enhance security of the electronic device.

In accordance with an aspect of the present disclosure, a method of using an electronic device is provided. The method includes comparing, when a request for an access to a resource of an electronic device is identified, a reliability level of a user and a security level of the resource and permitting the access to the resource when the reliability level is equal to or higher than the security level of the resource.

In accordance with another aspect of the present disclosure, a method of using an electronic device is provided. The method includes detecting a generated event of the electronic device and changing a reliability level of a user based on the detected event.

In accordance with another aspect of the present disclosure, an electronic device is provided. The electronic device includes at least one processor configured to drive modules, a memory configured to store security levels of a plurality of resources including a first resource and a reliability level, and an access control module configured to compare the reliability level and the security level of the first resource and to determine whether to permit a request for an access to the first resource.

In accordance with another aspect of the present disclosure, an apparatus for using an electronic device is provided. The apparatus includes a controller configured to control to compare, when a request for an access to a resource of the electronic device is identified, a reliability level of a user and a security level of the resource, and to permit the access to the resource when the reliability level is equal to or higher than the security level of the resource.

In accordance with another aspect of the present disclosure, an apparatus for using an electronic device is provided. The apparatus includes a controller configured to control to detect a generated event of the electronic device and to change a reliability level of a user based on the detected event.

According to various embodiments of the present disclosure, it is possible to control a user's access to resources of the electronic device according to a user's reliability level. Thus, the security of the resources of the electronic device can be enhanced. Further, according to embodiments of the present disclosure, it is possible to minimize an authentication to use the resources of the electronic device and protect resources having a relatively high security level.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram schematically illustrating an electronic device according to an embodiment of the present disclosure;

FIG. 2A illustrates an electronic device according to an embodiment of the present disclosure;

FIG. 2B is a flowchart illustrating a method of determining a reliability level of a user according to an embodiment of the present disclosure;

FIG. 3A illustrates a first example of a process of determining a reliability level of a user according to an embodiment of the present disclosure;

FIG. 3B illustrates a second example of a process of determining a reliability level of a user according to an embodiment of the present disclosure;

FIG. 3C illustrates a third example of a process of determining a reliability level of a user according to an embodiment of the present disclosure;

FIG. 4A is a first flowchart illustrating a process of using an electronic device through a comparison between a reliability level of a user and a security level of a resource according to an embodiment of the present disclosure;

FIG. 4B is a second flowchart illustrating a process of using an electronic device through a comparison between a reliability level of a user and a security level of a resource according to an embodiment of the present disclosure;

FIG. 5A illustrates a first example of a process of using an electronic device through a comparison between a reliability level of a user and a security level of a resource according to an embodiment of the present disclosure;

FIG. 5B illustrates a second example of a process of using an electronic device through a comparison between a reliability level of a user and a security level of a resource according to an embodiment of the present disclosure;

FIG. 5C illustrates a third example of a process of using an electronic device through a comparison between a reliability level of a user and a security level of a resource according to an embodiment of the present disclosure;

FIG. 6A illustrates a fourth example of a process of using an electronic device through a comparison between a reliability level of a user and a security level of a resource according to an embodiment of the present disclosure; and

FIG. 6B illustrates a fifth example of a process of using an electronic device through a comparison between a reliability level of a user and a security level of a resource according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

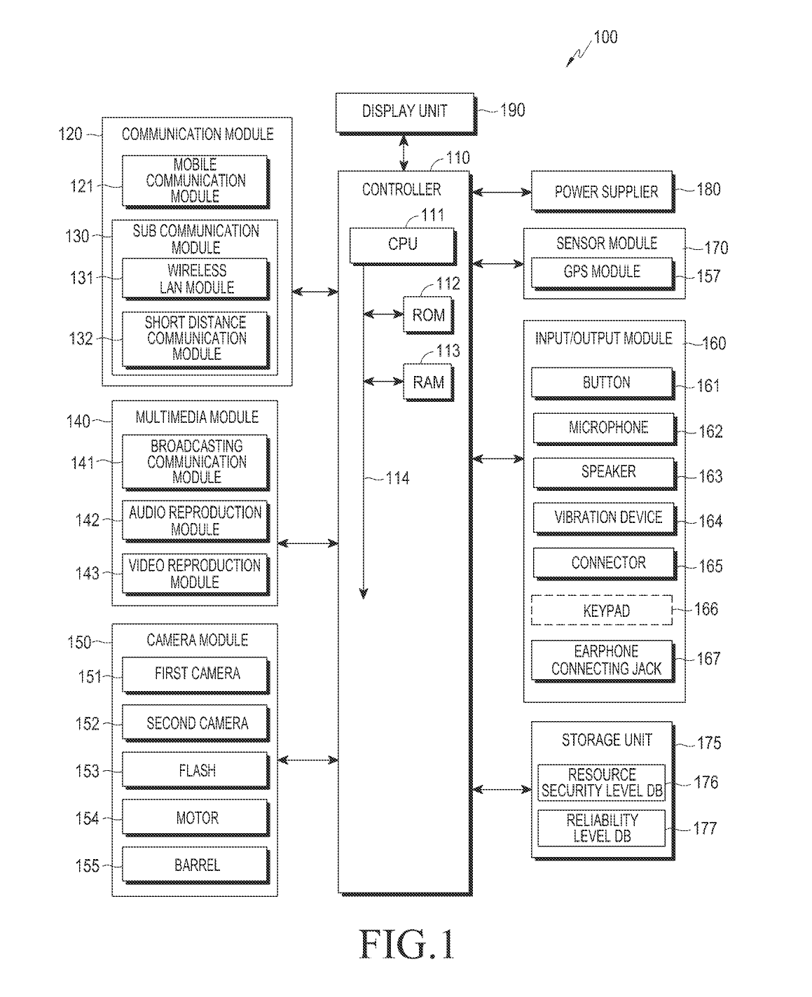

Hereinafter, various embodiments of the present disclosure will be described with reference to contents of the accompanying drawings in association with FIGS. 1 to 6B. However, the present disclosure is not limited or restricted by the various embodiments. The same reference numerals of each of the drawings may be designated to members performing the same function.

While terms including ordinal numbers, such as “first” and “second,” etc., may be used to describe various components, such components are not limited by the above terms. The terms are used merely for the purpose to distinguish an element from the other elements. For example, a first element could be termed a second element, and similarly, a second element could be also termed a first element without departing from the scope of the present disclosure. The terms used in this application is for the purpose of describing particular embodiments only and is not intended to be limiting of the disclosure. As used herein, the singular forms are intended to include the plural forms as well, unless the context clearly indicates otherwise.

FIG. 1 is a block diagram schematically illustrating an electronic device according to an embodiment of the present disclosure.

The electronic device according to an embodiment of the present disclosure may be a desktop Personal Computer (PC), a laptop PC, a Personal Digital Assistant (PDA), a Portable Multimedia Player (PMP), a tablet PC, a mobile phone, a video phone, a feature phone, a smart phone, an electronic book reader, a digital camera, a wearable device, a wireless device, a Global Positioning System (GPS) system, a hand-held device, a Motion Picture Experts Group (MPEG)-2 Audio Layer III (MP3) player, a camcorder, a game console, an electronic watch, a flat panel device, an electronic photograph, an electronic board, an electronic sign board, a projector, a navigation device, a black box, a set-top box, an electronic dictionary, a refrigerator, an air conditioner, a vacuum cleaner, an artificial intelligence robot, a television (TV), a Digital Versatile Disk (DVD) player, a stereo, an oven, a microwave oven, a washing machine, an air cleaner, a medical device, a vehicle device, a shipbuilding device, an aircraft device, a security device, agricultural, stock farm, and fishery equipment, electronic clothing, an electronic key, an electronic bracelet, or an electronic necklace. For example, such electronic devices may be driven by an Operating System (OS) such as ANDROID, iOS, WINDOWS, LINUS, SYMBIAN, TIZEN, or BADA. It is apparent to those skilled in the art that the electronic device and the OS according to various embodiments of the present disclosure are not limited to the above described examples. Referring to FIG. 1, an electronic device 100 may be connected with an external device (not shown) by using an external device connector such as a sub communication module 130, a connector 165, and an earphone connecting jack 167. The “external device” includes various devices attached to or detached from the electronic device 100 through a wire, such as an earphone, an external speaker, a Universal Serial Bus (USB) memory, a charger, a cradle/dock, a Digital Multimedia Broadcasting (DMB) antenna, a mobile payment related device, a health management device (such as a blood sugar tester and the like), a game machine, a navigation device, and the like. Further, the “external device” may include, for example, a Bluetooth communication device, a short distance communication device such as a Near Field Communication (NFC) device, a WiFi-Direct communication device, and a wireless Access Point (AC) which may be wirelessly connected to the electronic device 100. In addition, the external device may be another device, for example, a mobile phone, a smart phone, a tablet PC, a desktop PC, or a server.

Referring to FIG. 1, the electronic device 100 may include at least one of a controller 110, a communication module 120, the sub communication module 130, a multimedia module 140, a camera module 150, a GPS module 157, an input/output module 160, a sensor module 170, a storage unit 175, a power supplier 180, and a display unit 190. The communication module 120 may include a mobile communication module 121 and the sub communication module 130. The sub communication module 130 may include at least one of a wireless Local Area Network (LAN) module 131 and a short distance communication module 132. The multimedia module 140 may include at least one of a broadcasting communication module 141, an audio reproduction module 142, and a video reproduction module 143. The camera module 150 may include at least one of a first camera 151 and a second camera 152, a flash 153, a motor 154, and a barrel 155. The input/output module 160 may include at least one of a button 161, a microphone 162, a speaker 163, a vibration device 164, the connector 165, a keypad 166, and the earphone connecting jack 167.

The communication module 120 enables the electronic device 100 to be connected with an external device through mobile communication by using one antenna or a plurality of antennas (not shown) according to a control of the controller 110. The communication module 120 may transmit/receive a wireless signal for a voice call, a video call, a Short Message Service (SMS), or a Multimedia Message Service (MMS) to/from a mobile phone (not shown), a smart phone (not shown), a tablet PC, or another device (not shown) having a phone number input into the electronic device 100.

The sub communication module 130 may include at least one of the wireless LAN module 131 and the short distance communication module 132. For example, the sub communication module 130 may include only the wireless LAN module 131, only the short distance communication module 132, or both the wireless LAN module 131 and the short distance communication module 132.

The wireless LAN module 131 includes a WiFi module and may be connected to the Internet in a place where a wireless Access Point (AP) (not shown) is installed through an interworking with the controller 110. The wireless LAN module 131 may support a wireless LAN standard (IEEE802.11x) of the Institute of Electrical and Electronics Engineers (IEEE).

The short distance communication module 132 may provide a wireless short distance communication function through an interworking with the controller 110. The short distance communication module 132 may include a BLUETOOTH module, an Infrared Data Association (IrDA) module, a NFC module, and the like.

The multimedia module 140 may include at least one of the broadcasting communication module 141, the audio reproduction module 142, and the video reproduction module 143. The broadcasting communication module 141 may receive a broadcasting signal (for example, a TV broadcasting signal, a radio broadcasting signal, or a data broadcasting signal) and broadcasting supplemental information (for example, Electric Program Guide (EPG) or Electric Service Guide (ESG)) output from a broadcasting station through a broadcasting communication antenna (not shown) according to a control of the controller 110. The audio reproduction module 142 may reproduce a digital audio file (for example, a file having a file extension of .mp3, .wma, .ogg, or .wav) stored or received according to a control of the controller 110. The video reproduction module 143 may reproduce a digital video file (for example, a file having a file extension of .mpeg, .mpg, .mp4, .avi, .mov, or .mkv) stored or received according to a control of the controller 110. The video reproduction module 143 may reproduce the digital audio file.

The multimedia module 140 may include the audio reproduction module 142 or the video reproduction module 143 except for the broadcasting communication module 141. Further, the audio reproduction module 142 or the video reproduction module 143 of the multimedia module 140 may be included in the controller 110.

The camera module 150 may include at least one of the first camera 151 and the second camera 152 for photographing a still image or a video according to a control of the controller 110. Further, the first camera 151 or the second camera 152 may include an auxiliary light source (for example, a flash 153 providing light required for the photographing). The first camera 151 may be disposed on a front surface of the electronic device 100, and the second camera 152 may be disposed on a rear surface of the electronic device 100. Alternatively, the first camera 151 and the second camera 152 may be closely located to each other (for example, an interval between the first camera 151 and the second camera 152 is larger than 1 cm and smaller than 8 cm) and may photograph a three dimensional (3D) still image or a 3D video.

The GPS module 157 may receive radio waves from a plurality of GPS satellites (not shown) in Earth's orbit and calculate a position of the electronic device 100 by using Time of Arrival from the GPS satellites to the electronic device 100.

The input/output module 160 may include at least one of the button 161, the microphone 162, the speaker 163, the vibration device 164, the connector 165, the keypad 166, and the earphone connecting jack 167.

The buttons 161 may be formed on a front surface, a side surface, or a rear surface the housing of the electronic device 100, and may include (not shown) at least one of a power/lock button, a volume button, a menu button, a home button, a back button, a search button.

The microphone 162 may receive a voice or a sound to generate an electrical signal according to a control of the controller 110.

The speaker 163 may output sounds corresponding to various signals (for example, a wireless signal, a broadcasting signal, a digital audio file, a digital video file, taking a picture, and the like) of the mobile communication module 120, the sub communication module 130, the multimedia module 140, or the camera module 150 to the outside of the electronic device 100 according to a control of the controller 110. The speaker 163 may output a sound (for example, button tone corresponding to a phone call or ringing tone) corresponding to a function performed by the electronic device 100. One speaker 163 or a plurality of speakers 163 may be formed on a suitable position or positions of the housing of the electronic device 100.

The vibration device 164 may convert an electrical signal to a mechanical vibration according to a control of the controller 110. For example, when the electronic device 100 in a vibration mode receives a voice call from another device (not shown), the vibration device 164 may be operated. One vibration device 164 or a plurality of vibration devices 164 may be formed within the housing of the electronic device 100. The vibration device 164 may operate in response to a touch action of the user on a touch screen of the display unit 190 or successive motions of the touch on the touch screen.

The connector 165 may be used as an interface for connecting the electronic device 100 with an external device (not shown) or a power source (not shown). The electronic device 100 may transmit or receive data stored in the storage unit 175 of the electronic device 100 to or from an external device (not shown) through a wired cable connected to the connector 165 according to a control of the controller 110. Further, the electronic device 100 may receive power from a power source (not shown) through the wired cable connected to the connector 165 or charge a battery (not shown) by using the power source.

The keypad 166 may receive a key input from the user to control the electronic device 100. The keypad 166 may include a physical keypad (not shown) formed in the electronic device 100 or a virtual keypad (not shown) displayed on the touch screen of the display unit 190. The physical keypad (not shown) formed in the electronic device 100 may be excluded according to a capability or structure of the electronic device 100.

An earphone (not shown) may be inserted into the earphone connecting jack 167 to be connected with the electronic device 100.

The sensor module 170 may include at least one sensor for detecting a state of the electronic device 100. For example, the sensor module 170 may include the GPS module 157 for detecting signals from GPS satellites, a proximity sensor for detecting whether a user approaches the electronic device 100, an illuminance sensor (not shown) for detecting an amount of ambient light of the electronic device 100, a motion sensor (not shown) for detecting an operation (for example, a rotation of the electronic device 100, or an acceleration or a vibration applied to the electronic device 100) of the electronic device 100, a geo-magnetic sensor (not shown) for detecting an orientation by using the Earth's magnetic field, a gravity sensor for detecting an orientation of the gravity, and an altimeter for measuring an atmospheric pressure to detect an altitude. The sensors of the sensor module 170 according to various embodiments of the present disclosure are not limited to the aforementioned embodiments. At least one sensor may detect a state, generate a signal corresponding to the detection, and transmit the signal to the controller 110. The sensors of the sensor module 170 may be added or omitted according to the capability of the electronic device 100.

The storage unit 175 may store a signal or data input/output according to at least one operation of the communication module 120, the sub communication module 130, the multimedia module 140, the camera module 150, the GPS module 157, the input/output module 160, the sensor module 170, or the touch screen of the display unit 190. The storage unit 175 may store a control program and applications for controlling the electronic device 100 or the controller 110. The term “storage unit” may be construed as meaning including at least one of the storage unit 175 and a non-volatile Read-Only Memory (ROM) 112 or a volatile Random Access Memory (RAM) 113 within the controller 110, and include a storage device such as a Hard Disk Drive (HDD) or a Solid State Disk or Solid State Drive (SSD).

The storage unit 175 may further include an external memory, for example, Compact Flash (CF), Secure Digital (SD), Micro-SD, Mini-SD, extreme Digital (xD), or a memory stick.

The storage unit 175 according to various embodiments of the present disclosure may include a resource security level database or a reliability level database, and the database may be generated within the electronic device and then pre-stored in the storage unit 175, or downloaded from a preset external device (for example, a cloud server or an electronic device designated by the user) and then stored.

Since the reliability level database is a reliability level database of the user, when the electronic device supports multiple user accounts, reliability level data having the same or different information for each account may be included. For example, when accounts registered in the electronic device include a first user account and a second user account, the storage unit 175 according to embodiments of the present disclosure may include a first reliability level DataBase (DB) 177 corresponding to the first user account and a second reliability level DB 177 corresponding to the second user account. Various embodiments of the present disclosure in which the controller 110 generates, refers, or updates the reliability level DB 177 (first reliability level DB 177 or second reliability level DB 177) corresponding to the logged-on account (first user account or second user account) may be implemented below.

The power supplier 180 may supply power to one battery or a plurality of batteries (not shown) arranged at the electronic device 100 according to a control of the controller 110. The one battery or the plurality of batteries (not shown) supply power to the electronic device 100. Further, the power supplier 180 may supply power input from an external power source (not shown) through a wired cable connected to the connector 165 to the electronic device 100. In addition, the power supplier 180 may supply power wirelessly input from the external power source to the electronic device 100 through a wireless charging technology.

The display unit 190 may be implemented by a Liquid Crystal Display (LCD), an Organic Light Emitting Diode (OLED), a Passive Matrix OLED (PMOLED), or an active matrix OLED (AMOLED), and may output various display information. The display unit 190 may include a touch screen (for example, a Touch Screen Panel (TSP)) implemented in a capacitive type, an infrared type, or an acoustic wave type, and a touch screen controller. Further, the display unit 190 may include a controller corresponding to a panel which can recognize an input by the user through a pen (for example, an S pen) in an electromagnetic induction type as well as the touch screen.

The display unit 190 may provide user interfaces corresponding to various services (for example, a call, data transmission, broadcasting, and photography) to the user. The touch screen of the display unit 190 may transmit an analog signal corresponding to at least one touch input into the user interface to the touch screen controller (not shown). The display unit 190 may receive at least one touch through a user's body (for example, fingers including a thumb) or a touchable input means (for example, a stylus pen) through the touch screen.

In various embodiments of the present disclosure, the touch is not limited to the contact between the display unit (for example, the touch screen) and the user's body or the touchable input means, and may include a non-contact (for example, a case where a detectable interval between the touch screen and the user's body or the touchable input means is smaller than or equal to 1 mm).

The touch screen controller may convert an analog signal received from the touch screen of the display unit 190 to a digital signal (for example, X and Y coordinates) and transmit the converted digital signal to the controller 110. The controller 110 may control the touch screen of the display unit 190 by using the digital signal received from the touch screen controller. For example, the controller 110 may control an application icon displayed on the display unit 190 to be selected or a corresponding application to be executed in response to the touch. At this time, the touch screen controller may be included in the controller 110.

The controller 110 may include a CPU 111, the ROM 112 for storing a control program for controlling the electronic device 100, and the RAM 113 for storing a signal or data input from the outside of the electronic device 100 or storing an operation performed in the electronic device 100. The CPU 111 may operate in a type of a multi core such as a single core, a dual core, a triple core, or a quadruple core. The ROM 112 may include, for example, at least one of a One Time Programmable (OTP) memory, a mask Read Only Memory (ROM), a Programmable Read Only Memory (PROM), an Erasable and Programmable Read Only Memory (EPROM), an Electrically Erasable and Programmable Read Only Memory (EEPROM), and a flash memory. The RAM 113 may include, for example, at least one of a Dynamic Random Access Memory (DRAM), a Static Random Access Memory (SRAM), and a Synchronous Dynamic Random Access Memory (SDRAM).

The CPU 111, the ROM 112, and the RAM 113 may be mutually connected to each other through an internal bus 114.

The controller 110 may control at least one of the mobile communication module 120, the sub communication module 130, the multimedia module 140, the camera module 150, the GPS module 155, the input/output module 160, the sensor module 170, the storage unit 175, the power supplier 180, and the display unit 190. Meanwhile, in a method of using the electronic device, the controller 110 according to embodiments of the present disclosure may control a series of operations including an operation of, when a request for an access to the resource of the electronic device is identified, identifying and comparing a reliability level of the user and a security level of the access requested resource, and an operation of, when the reliability level of the user is equal to or higher than the security level of the access requested resource, permitting the access of the access requested resource. A detailed operation of the controller 110 according to various embodiments of the present disclosure will be described below.

Hereinafter, the resource according to various embodiments of the present disclosure will be described.

In embodiments of the present disclosure, an application or data of which a security level can be set is referred to as a resource of the electronic device, and a request for executing an application or using data is referred to as a request for an access to the resource. For example, in embodiments of the present disclosure, a request for deleting the resource (for example, application or data) may be included in the request for the access to the resource.

For example, the application may be an application installed in the electronic device when the electronic device is released, or an application downloaded through an application market and then installed in the electronic device. Further, the application may be a setting application (for example, application providing a setting menu of a feature phone) which can set a use environment (for example, change an authentication number or select an authentication method) of the electronic device.

For example, the data may include contents (for example, a document file, a picture file, or an image file) in the unit of files available in the electronic device.

Various embodiments of the present disclosure will be described below with reference to the above description of the resource.

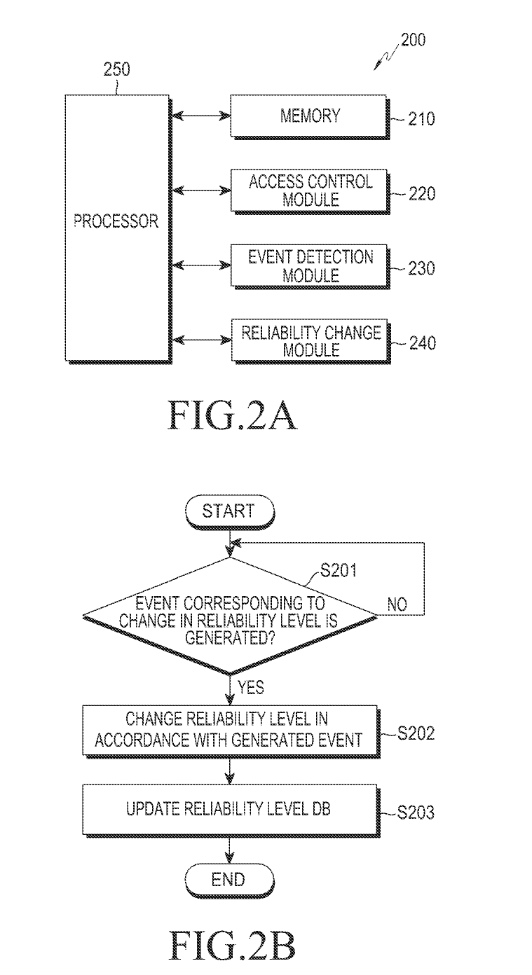

FIG. 2A illustrates the electronic device according to an embodiment of the present disclosure.

Referring to FIG. 2A, the electronic device 200 according to the present embodiment may include a memory 210, an access control module 220, an event detection module 230, a reliability change module 240, and a processor 250.

The memory 210 may store security levels of a plurality of resources including a first resource, and a reliability level.

The access control module 220 may compare the reliability level and the security level of the first resource and determine whether to permit a request for an access to the first resource.

The event detection module 230 may detect an event generated in the electronic device according to the use of the electronic device 200.

The reliability change module 240 may change at least one reliability level stored in the memory 210 based on the detected event.

The electronic device 200 according to embodiments of the present disclosure illustrated in FIG. 2A may further include an automatic security level generation module (not shown) set to automatically determine a security level of each of the resources based on permission of each of the plurality of resources and store the determined security level in the memory 210.

Further, the electronic device 200 according to embodiments of the present disclosure illustrated in FIG. 2A may include a manual security level generation module (not shown) to determine security levels of one or more resources among the plurality of resources based on the request for the access and store the determined security levels in the memory 210.

In addition, the electronic device 200 according to embodiments of the present disclosure illustrated in FIG. 2A may further include an authentication providing module that provides at least one authentication method according to a result of the comparison between the reliability level and the security level of the first resource, and the reliability change module 240 may change the reliability level according to whether an authentication is successful through the authentication method provided by the authentication providing module.

The authentication method provided by the authentication providing module may include at least one of slide unlock, password input, pattern input, face recognition, fingerprint recognition, iris recognition, biometrics, or picture password.

The processor 250 may control an operation of at least one of the access control module 220, the event detection module 230, the reliability change module 240, the automatic security level generation module, the manual security level generation module, and the authentication providing module, and at least one of the modules may exist separately or may be included in the processor 250.

The electronic device 100 according to embodiments of the present disclosure illustrated in FIG. 1 and the electronic device 200 according to embodiments of the present disclosure illustrated in FIG. 2A may be the same as each other or individual electronic devices different from each other.

For example, various embodiments of the present disclosure may be implemented by the controller 110 illustrated in FIG. 1 and the processor 250 illustrated in FIG. 2A which may perform the same operation, or implemented by the controller 110 and the processor 250 which may perform a complementary function or substitutive operation.

For example, embodiments of the present disclosure may be implemented by replacing the controller 110 with the processor 250, by replacing the processor 250 with the controller 110, or by providing the controller 110 and the processor 250 together.

FIG. 2B is a flowchart illustrating a method of determining a reliability level according to an embodiment of the present disclosure. The electronic device performing the method according to the present embodiment may correspond to the electronic device 200 illustrated in FIG. 2A.

In operation S201, the processor 250 may detect the generation of an event corresponding to a change in a reliability level through the event detection module 230. In operation S202, the processor 250 may change the reliability level based on the generated event through the reliability change module 240. In operation S203, the processor 250 may control a reliability level DB to be updated in accordance with the change in the reliability level through the reliability change module 240. According to embodiments of the present disclosure, when it is identified that the user makes a request for the access to the resource, the reliability level of the user is compared with the security level of the access requested resource, and then it may be determined whether to permit the access to the resource of the user.

According to embodiments of the present disclosure, it may be detected whether an event for changing the reliability level of the user is generated while the electronic device operates.

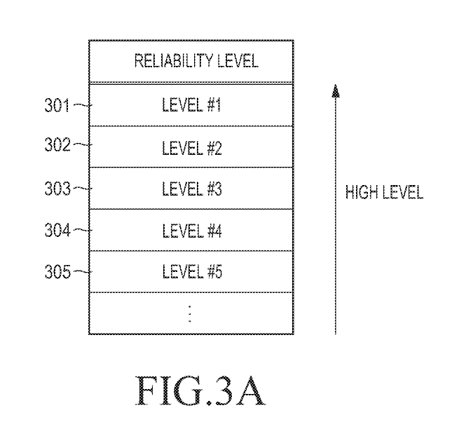

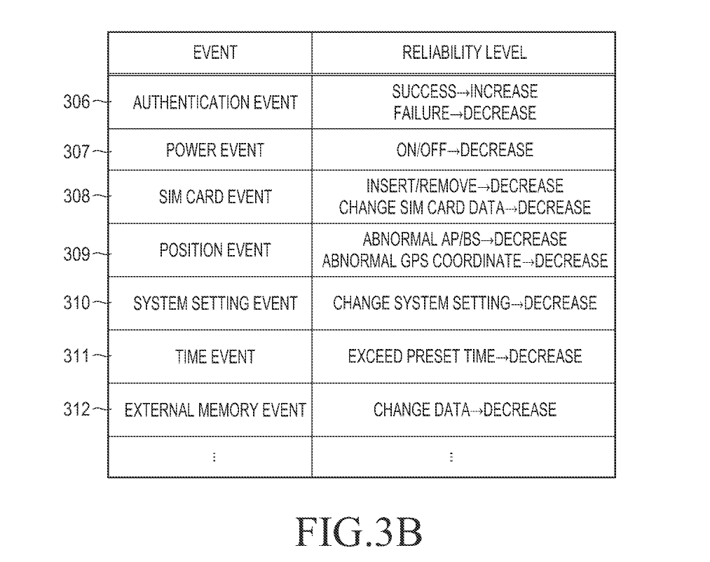

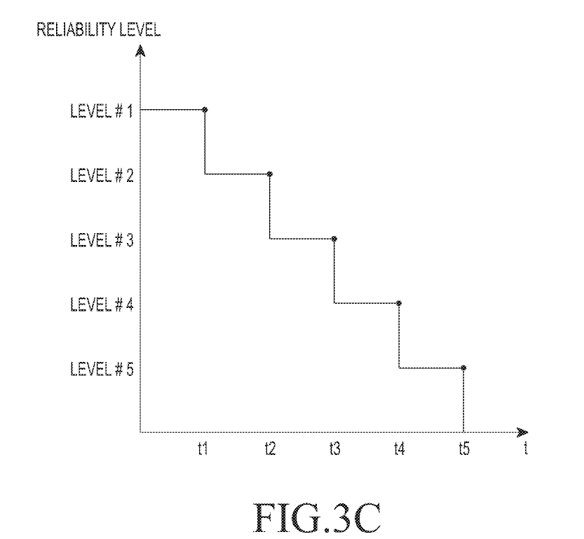

FIG. 3A illustrates a reliability level of the user according to an embodiment of the present disclosure.

Referring to FIG. 3A, the reliability level of the user according to the present embodiment may be one of a plurality of reliability levels. Two or more of the plurality of reliability levels may indicate reliabilities the same as each other or different from each other. For example, the reliability level of the user may be one of five reliability levels (level #5 305, level #4 304, level #3 303, level #2 302, and level #1 301). For example, level #5 305 may be set as a lowest level of the five reliability levels and level #1 301 may be set as a highest level of the five reliability levels. This is only one embodiment, and the number of reliability levels and super/sub relations between reliability levels are not limited in the present embodiment.

The reliability level of the user according to embodiments of the present disclosure may be changed from one (for example, level #3 303) of the plurality of reliability levels to another one (for example, level #2 302) according to the generation of a preset event.

FIG. 3B illustrates an event for changing a reliability level of the user according to an embodiment of the present disclosure.

Referring to FIG. 3B, the event according to the present embodiment may include at least one of an authentication event 306, a power event 307, a Subscriber Identity Module (SIM) card event 308, a position event 309, a system setting event 310, a time event 311, and an external memory event 312. It is apparent to those skilled in the art that the event for changing the reliability level of the user is not limited to the illustration of FIG. 3B.

The authentication event 306 may be generated when the user succeeds or fails the authentication after the event (for example, password request) for making a request for the authentication to the user is generated. At this time, embodiments of the present disclosure may provide the user with at least one of authentication methods such as password input, pattern input, face recognition, fingerprint recognition, iris recognition, and biometrics.

According to embodiments of the present disclosure, when the electronic device switches from an idle mode to an active mode and an event for making a request for inputting a pattern to the user is generated, the reliability level may be increased when the same pattern as a pattern preset by the user is input and the reliability level may be decreased when a different pattern from the preset pattern is input.

The power event 307 may be generated when power of the electronic device is turned on or off (including rebooting). For example, the power event may be generated according to a soft key or hard key of power on or off.

According to embodiments of the present disclosure, the reliability level may be decreased when booting (or rebooting) is completed according to a request for power-on of the electronic device. When a request for turning off power is made, the reliability level may be first decreased before power-off, and then the power is turned off after the reliability level has been decreased.

The SIM card event 308 may be generated when a state of a SIM card (for example, a Universal Subscriber Identity Module (USIM) card) is changed.

In embodiments of the present disclosure, at least one of cases where a SIM card is inserted, an inserted a SIM card is removed, and a SIM card (for example, SIM card having an Integrated Circuit Card Identifier (ICCID) and an International Mobile Subscriber Identity (IMSI) different from those of an existing SIM card) different from the existing SIM card is inserted may be determined as a case where the state of the SIM card is changed.

According to embodiments of the present disclosure, when the inserted SIM card is removed, the reliability level may be decreased.

The position event 309 may be generated when it is determined that the electronic device is located at an abnormal or unusual place.

According to embodiments of the present disclosure, a usual (or normal) position of the electronic device may be determined with reference to a position database that has recorded the position of the electronic device for a preset period. For example, the position database may be stored within the electronic device or provided from the outside.

According to embodiments of the present disclosure, the position database may include a list of at least one Access Point (AP) found by a WiFi module for a preset period. When a new AP (for example, an AP which has not been found within a movement radius of the electronic device for a preset period) which is not included in the position database is found, the reliability level may be decreased.

Further, according to embodiments of the present disclosure, the position database may include a list of at least one base station connected using the mobile communication module of the electronic device for a preset period. When it is determined that the electronic device accesses a base station (for example, a base station which the electronic device does not usually access) which is not included in the position database, the reliability level may be decreased.

In addition, according to embodiments of the present disclosure, the position database may include accumulated data on a movement pattern of the electronic device through the GPS module of the electronic device for a preset period. When it is determined that the electronic device is located at a GPS position (for example, a position beyond the usual movement pattern of the electronic device) which is not included in the position database, the reliability level may be decreased. For example, when the electronic device is located at a position where the electronic device has not been located for a preset period, the reliability level may be decreased.

The system setting event 310 may be generated when a setting (preference) of the electronic device is changed.

With respect to the use of the electronic device, the user may change various system settings, such as changing a password in a password authentication method, changing a pattern in a pattern input authentication method, and changing a user's account name or account password.

Therefore, according to embodiments of the present disclosure, when the event for changing the setting of the electronic device is generated (for example, when a setting value of preference is changed), the reliability level may be decreased.

The time event 311 may be generated when a use time for which the electronic device is used or a standby time for which the electronic device is not used exceeds a threshold (hereinafter, referred to as a reference time).

FIG. 3C is a graph illustrating a relation between a time event and a reliability level of the user according to an embodiment of the present disclosure.

Referring to FIG. 3C, the reliability level of the user may be changed whenever the use time for which the electronic device is used or the standby time for which the electronic device is not used exceeds a reference time t1, t2, t3, t4, or t5. For example, as the use time or the standby time sequentially exceeds t1, t2, t3, t4, and t5, the reliability level may be sequentially lowered according to an order of level #1, level #2, level #3, level #4, and level #5. When the reference time is 30 minutes, t1, t2, t3, t4, and t5 may become 30 minutes, 60 minutes, 90 minutes, 120 minutes, and 150 minutes, respectively.

According to embodiments of the present disclosure, an interface which can prevent the reliability level from being decreased before the use time or the standby time exceeds the reference time may be provided. For example, by extending the reference time or resetting the standby time through the provided interface, the user can prevent the reliability level from being decreased.

The external memory event 312 may be generated when data stored in the external memory inserted into the electronic device is changed (for example, when data is copied, deleted, or moved).

In general, the user may insert data (for example, an accredited certificate or a confidential document) having a relatively high security level into the available external memory or remove the insertion to store the data. Therefore, according to embodiments of the present disclosure, when a change in the data stored in the external memory is detected (for example, when a request for copying an accredited certificate is made), the reliability level may be decreased.

In embodiments of the present disclosure, the external memory may include at least one of SD, Micro-SD, CF, Mini-SD, xD, and a memory stick, and it is apparent to those skilled in the art the external memory is not limited thereto.

According to embodiments of the present disclosure, when the reliability level is changed (for example, decreased) according to the generation of one event, the database may be controlled to update the reliability level stored in the electronic device in accordance to the change in the reliability level. As described above, based on the reliability level changed according to the generation of the event for changing the reliability level of the user, embodiments of the present disclosure may determine whether to permit the request for the access to the resource by the user.

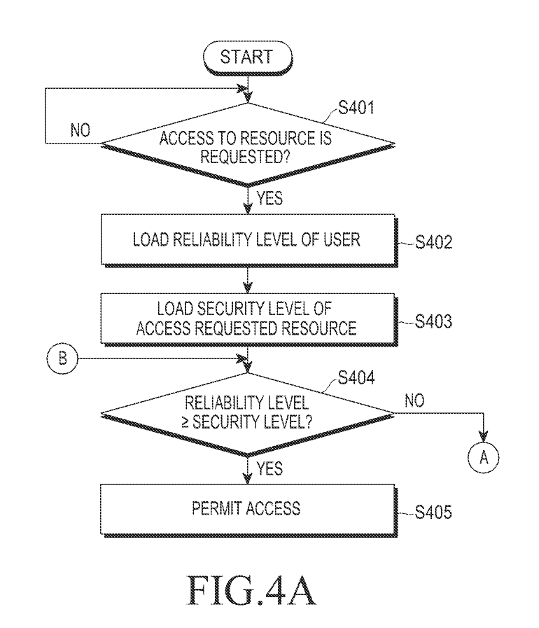

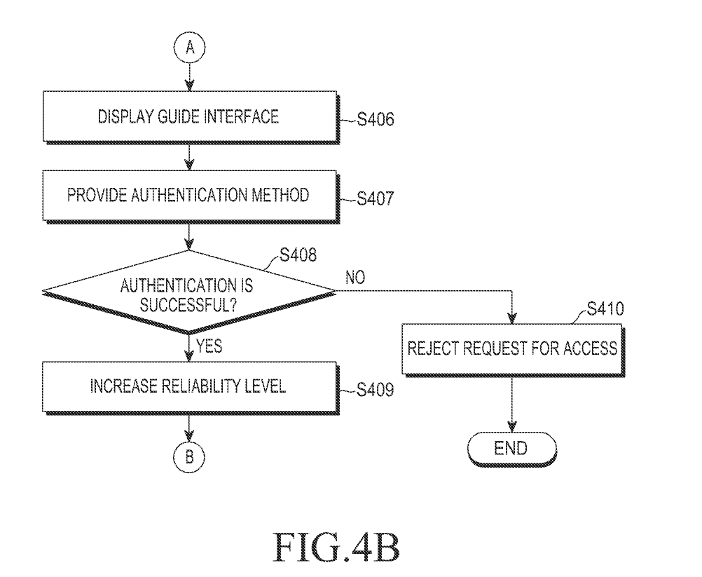

FIG. 4A is a flowchart illustrating a method of using the electronic device through a comparison between the reliability level of the user and the access requested security level according to an embodiment of the present disclosure. The electronic device according to the present embodiment may correspond to the electronic device 200 illustrated in FIG. 2A.

Referring to FIG. 4A, when the processor 250 identifies a request for an access to a resource in operation S401, the processor 250 loads the access requested reliability level of the user from the memory 210 in operation S402, and loads a security level of the access requested resource from the memory 210 in operation S403.

According to embodiments of the present disclosure, security levels of the resources (for example, an application, a menu, contact data, and a document file) of the electronic device may be set for each item of the resources. According to embodiments of the present disclosure, the security level of the resource (for example, application) may be automatically set according to a setting of the electronic device or may be manually set by the user.

Although operations S402 and S403 are depicted as sequentially performed in the present embodiment, orders of the steps may be exchanged, some operations of the steps may be simultaneously performed or may be omitted, or some steps may be added.

In operation S404, the processor 250 compares the reliability level of the user and the security level of the access requested resource to determine whether the reliability level of the user is equal to or higher than the security level of the access requested resource through the access control module 220.

As a result of the determination in operation S404, when it is determined that the reliability level of the user is equal to or higher than the security level of the access requested resource through the access control module 220, the processor 250 may permit the access to the access requested resource of the user in operation S405.

According to embodiments of the present disclosure, the reliability level of the user may be continuously changed by events generated while the electronic device is used.

FIG. 4B illustrates a method of changing a reliability level of the user according to an embodiment of the present disclosure.

Referring to FIG. 4B, in operation S406, a guide interface informing that the reliability level of the user is lower than the security level of the access requested resource may be displayed.

In operation S407, an authentication method which can change (for example, increase) the reliability level of the user may be provided.

In operation S408, it is determined whether an authentication performed using the authentication method provided in operation S407 is successful.

When it is determined in operation S408 that the authentication is successful, the reliability level of the user may be increased in operation S409. In operation S410, the request for access may be rejected, and a reliability level DB may be updated by decreasing the reliability level of the user.

In some implementations, by proceeding to B of FIG. 4A, operation S404 in which the reliability level of the user and the security level of the access requested resource are compared may be performed.

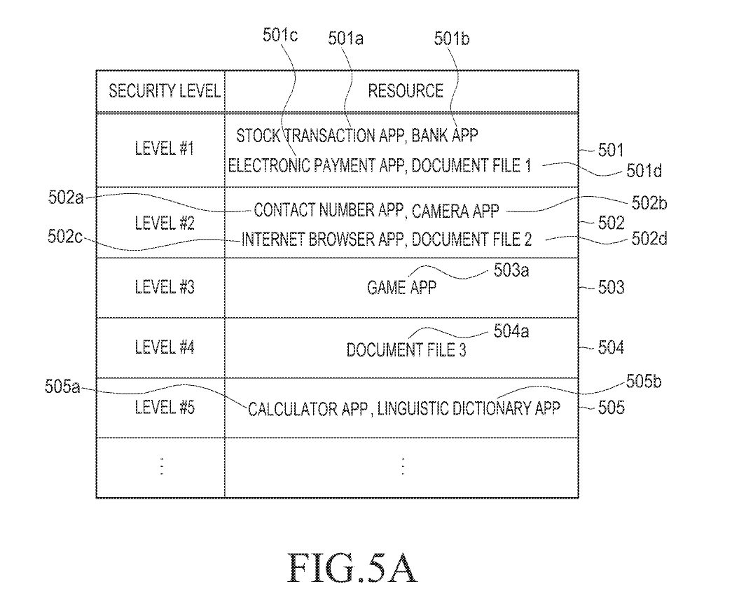

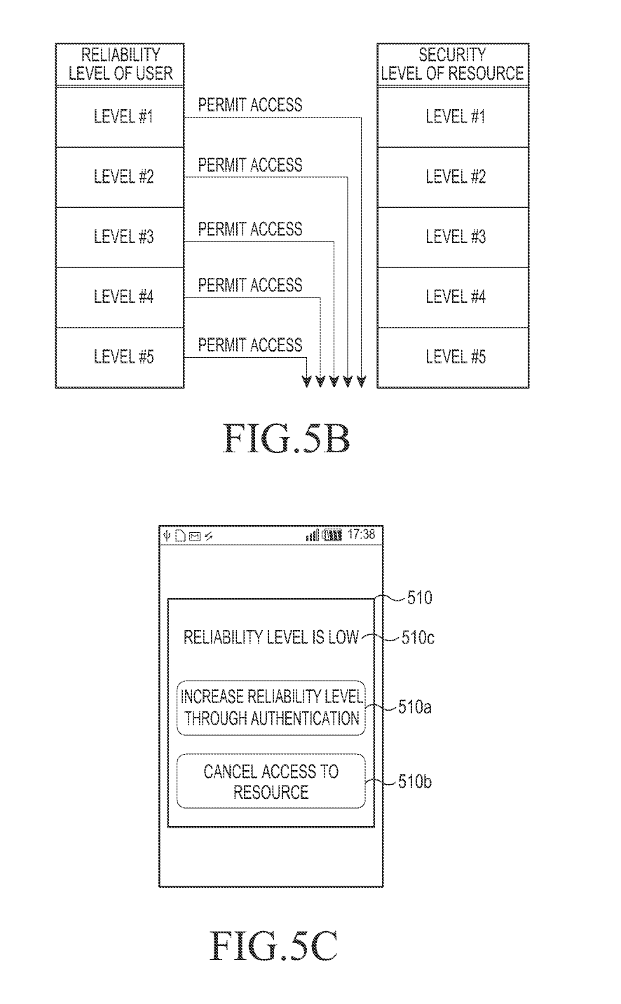

FIG. 5A illustrates a security level of the resource of the electronic device according to an embodiment of the present disclosure.

Referring to FIG. 5A, the security level of the resource according to the present embodiment may be one of a plurality of security levels. Two or more of the plurality of security levels may indicate security levels the same as each other or different from each other.

For example, the security level of the resource may be one of five security levels (level #1 501, level #2 502, level #3 503, level #4 504, and level #5 505). For example, level #5 505 may be set as a lowest level of the five security levels and level #1 501 may be set as a highest level of the five security levels. The number of security levels and super/sub relations between security levels are not limited in the present embodiment.

According to the present embodiment, among the resources of the electronic device, resource items corresponding to a reference number 501 may be set as the security level of level #1 501, resource items corresponding to a reference number 502 may be set as the security level of level #2 502, resource items corresponding to a reference number 503 may be set as the security level of level #3 503, resource items corresponding to a reference number 504 may be set as the security level of level #4 504, and resource items corresponding to a reference number 505 may be set as the security level of level #5 505.

For example, security levels of applications of a stock transaction 501a, a bank transaction 501b, and an electronic payment 501c may be automatically set as level #1 501 according to each system setting. A security level of a first document file 501d may be set as level #1 501 by the user.

For example, security levels of applications of a contact number 502a, a camera 502b, and an Internet browser 502c may be automatically set as level #2 502. A security level of a second document file 502d may be manually set as level #2 502 by the user.

For example, a security level of an application of a game 503a may be automatically set as level #3 503. A security level of a third document file 504a may be manually set as level #4 504. Security levels of applications of a calculator 505a and a linguistic dictionary 505b may be automatically set as level #5 505.

According to an embodiment, the security levels of the resource items (applications 501a, 501b, 501c, 502a, 502b, 502c, 503a, 505a, and 505b) automatically set by the system setting in the above description may alternatively be manually set by the user instead of the automatic setting.

According to embodiments of the present disclosure, the automatic setting of the security level of the resource (for example, application) may be performed with reference to permission information on each application.

For example, when the electronic device according to embodiments of the present disclosure is driven through an ANDROID OS, permission (right) information on the application may be identified from a predetermined database (for example, a file of AndroidManifest.xml), and thus permitted rights for the application may be determined. For example, an application having the permitted rights of READ_PROFILE and WRITE_PROFILE of the ANDROID OS (for example, permitted rights of reading and writing of a profile) may be assigned the rights for processing personal information on the user (user personal profile data), and an application having the permitted rights of the network may be assigned the rights for performing data communication.

Further, according to embodiments of the present disclosure, when a new resource is generated (for example, when a new application is installed or new data is generated), an interface that can set a security level of the new resource may be provided, and the security level of the new resource may be set as a level selected by the user through the interface.

The security level of the application may be automatically set according to a type of preset one or more rights referred to when the security level is automatically set among the rights permitted for the application on the OS (for example, an ANDROID OS). For example, the application having the rights of an access (processing) to personal information of the user and rights of data communication may have the security level of level #1 501, the application having the rights of data communication may have the security level of level #2 502 or level #3 503, and the application having no rights of the access to the personal information and no rights of data communication may have the security level of level #4 504 or level #5 505.

According to embodiments of the present disclosure, the application having a particular permission is set to have the security level of a particular level. For example, when the application of 501c having the same particular permission as those of the applications of 501a and 501b (for example, preset permission referred to when the security level is automatically set) is installed after the application of 501a and the application of 501b have the same preset permission referred when the security level is automatically set and they are automatically set as the security level of level #1 501, the security level of the application of 501c may be automatically set as level #1 501.

A result of the setting of the security level of the resource may be stored in the resource security level DB. When the security level of the resource is changed, the resource security level database may be updated to reflect the changed matter.

FIG. 5B illustrates an example of determining whether to permit an access to the resource based on the reliability level of the user and the security level of the resource according to an embodiment of the present disclosure.

Referring to FIG. 5B, when the reliability level of the user is equal to or higher than the security level of the access requested resource, the user may access (for example, use or execute) the access requested resource.

For example, when the reliability level is level #1, access to all resources having the security levels from level #1 to level #5 may be permitted. When the reliability level is level #2, access to all resources having the security levels from level #2 to level #5 may be permitted.

In contrast, when it is identified that the reliability level of the user is lower than the security level of the access requested resource, the request for the access is not permitted. When the request for the access is not permitted, the user may re-attempt the access to the resource by increasing the reliability level, or may end the access to the resource.

According to embodiments of the present invention, when the reliability level of the user is lower than the security level of the access requested resource, a guide interface informing of the fact may be displayed.

FIG. 5C illustrates a screen of the guide interface according to an embodiment of the present disclosure.

Referring to FIG. 5C, a guide interface 510 according to the present embodiment may include a guide message 510c, a first soft button 510a, and a second soft button 510b.

The guide message 510c displays a guidance message such as “the reliability level is low,” and thus may allow the user to recognize that the reliability level of the user is lower than the security level of the access requested resource.

According to embodiments of the present disclosure, the user may re-attempt the access to the resource by increasing the reliability level of the user through the guide interface 510 or may end the access to the resource. For example, the user may increase the reliability level of the user by selecting the first soft button 510a to perform an additional authentication. When the reliability level of the user increases, the user may make a request for re-attempting the access to the resource.

The user may make a request for canceling (or ending) the access to the resource by selecting the second soft button 510b.

The first soft button 510a of the guide interface 510 according to the present embodiment may provide an authentication method for the additional authentication of the user. For example, the authentication method may include at least one of various authentication methods such as slide unlock, password input, pattern input, face recognition, fingerprint recognition, iris recognition, other biometrics, and picture password. In providing the authentication method, embodiments of the present disclosure may provide one authentication method such as password input or pattern input, or an authentication method generated by combining a plurality of authentication methods in which all of multiple methods such as face recognition and fingerprint recognition must be authenticated.

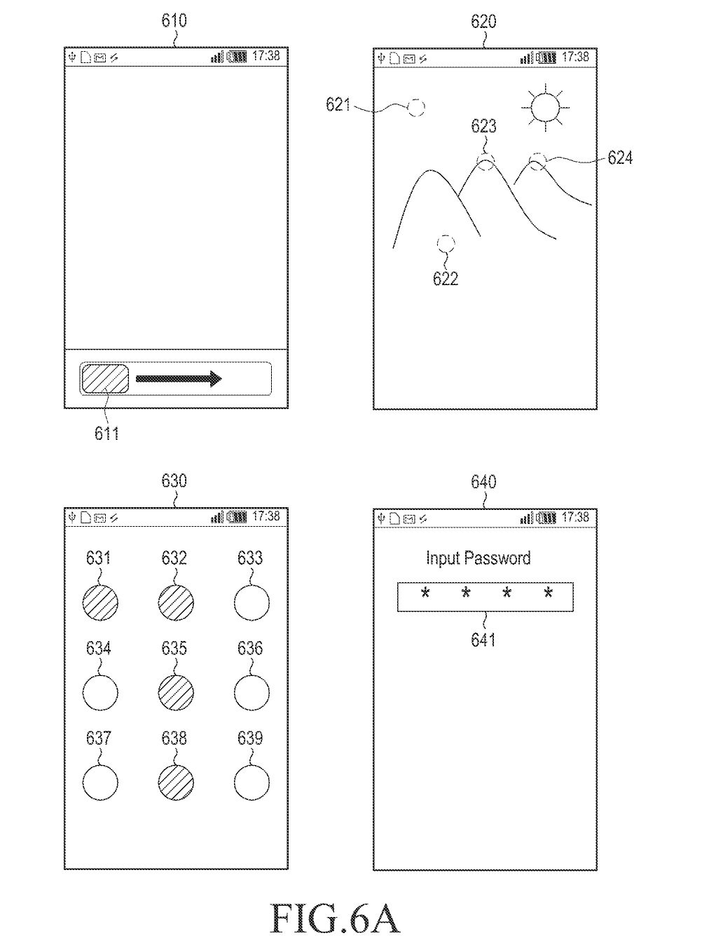

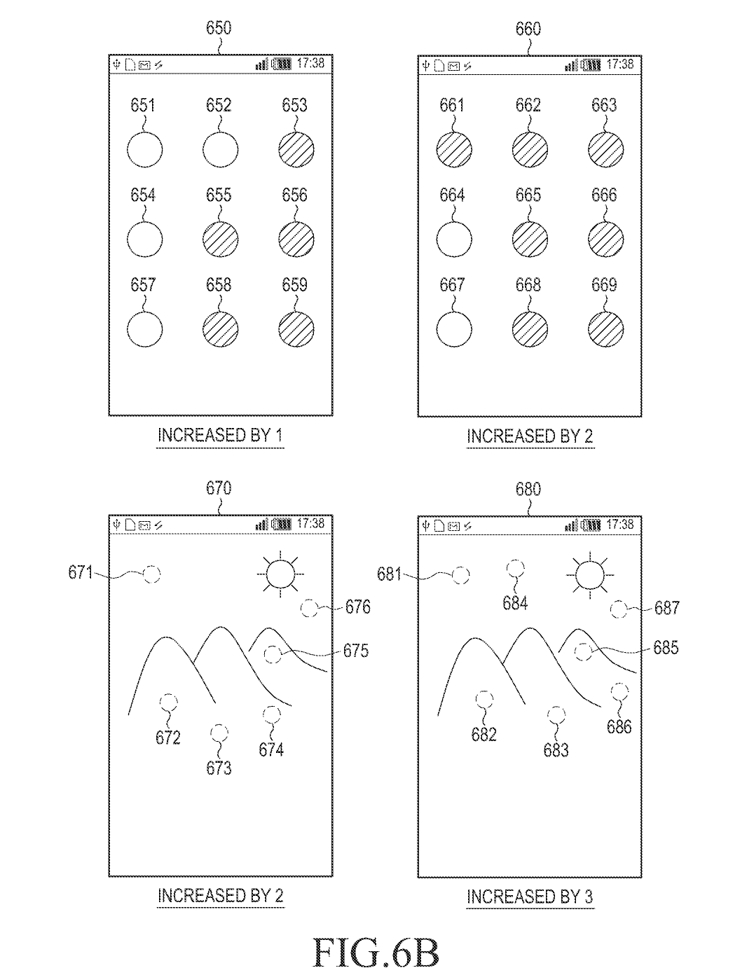

FIG. 6A illustrates authentication methods provided by embodiments of the present disclosure, and it is apparent to those skilled in the art that the authentication method is not limited to the illustration according to an embodiment of the present disclosure.

Referring to FIG. 6A, a screen 610 provides an authentication method of slide unlock. For example, the authentication may be performed by sliding a soft key 611 in a preset direction. A screen 620 provides an authentication method of picture password. For example, the authentication may be performed by sequentially touching (for example, dragging) preset positions 621, 622, 623, and 624 of an image. A screen 630 provides an authentication method of pattern input. For example, the authentication may be performed by inputting a pattern including preset input points (for example, points 631, 632, 635, and 638) among input points 631 to 639. A screen 640 provides an authentication method of password input. For example, the authentication may be performed by inputting a password 641 (for example, a password having four or five figures).

According to embodiments of the present disclosure, an increase value (increment) of the reliability level which increases when the authentication is successful may be preset independently for each authentication method.

FIG. 6B illustrates an example where the reliability level of the user increases for each authentication method according to an embodiment of the present disclosure.

Referring to FIG. 6B, an authentication method of pattern input provided through a screen 650 may increase the reliability level of the user by 1 when the authentication is successful.

An authentication method of picture password provided through a screen 670 may increase the reliability level of the user by 2 when the authentication is successful.

According to embodiments of the present disclosure, even in the same authentication method, the increase value (increment) of the reliability level which is increased when the authentication is successful may be differently set for each difficulty of the authentication method according to a difference in difficulties of the authentication method.

For example, the authentication method of pattern input provided through the screen 650 may correspond to an authentication method using five input points, and the authentication method of pattern input provided through the screen 660 may correspond to an authentication method using sevent input points. The screens 650 and 660 provide the same type of authentication method, but the authentication method of pattern input provided through the screen 660 may have a difficulty relatively higher than that of the authentication method of pattern input provided through the screen 650.

Accordingly, when the authentication is successful by inputting a pattern including five input points 653, 655, 656, 658, and 659 among input points 651 to 659, the reliability level may be increased by 1. Further, when the authentication is successful by inputting a pattern including seven input points 661, 662, 663, 665, 666, 668, and 669 among input points 661 to 669, the reliability level may be increased by 2.

The authentication method of picture password provided through the screen 670 corresponds to an authentication method using picture password including six positions 671 to 676, and the authentication method of picture password provided through the screen 680 corresponds to an authentication method using picture password including seven positions 681 to 687. The screens 670 and 680 provide the same authentication method (for example, picture password), but the authentication method of the screen 680 may be relatively higher than the authentication method of screen 670.

Accordingly, in embodiments of the present disclosure, when the authentication method of picture password is provided, the reliability level of the user increases by 2 if the authentication by the authentication method of picture password provided through the screen 670 is successfully performed, and the reliability level of the user increases by 3 if the authentication by the authentication method of picture password provided through the screen 680 is successfully performed.

In providing the aforementioned authentication methods, embodiments of the present disclosure may provide the authentication methods in various types according to a result of a comparison between the reliability level of the user having made the request for the access and the security level of the access requested resource (for example, according to whether the security level of the access requested resource is high or low), and the user may perform the authentication by the provided authentication methods.

As the security level of the access requested resource is high, various types of authentication methods may be provided to increase the reliability level of the user. Accordingly, when the security level of the access requested resource is higher than the reliability level of the user, embodiments of the present disclosure may provide an authentication method of rapidly increasing the reliability level when the authentication is successful in order not to generate a problem of requiring an additional authentication even though the authentication method has been performed.

For example, when the security level of the access requested resource is equal to a highest level (for example, level #1 501 in FIG. 5A), the reliability level is increased (for example, by 5) when the authentication is successful by providing a plurality of authentication methods (for example, 660 and 680 in FIG. 6B) or the authentication may be requested by providing one authentication method (for example, 680 in FIG. 6B) having a high difficulty. An authentication method of significantly increasing the reliability level of the user (for example, by 5) when the authentication is successful may be provided. In contrast, when the security level of the access requested resource is low (for example, level #4 504 in FIG. 5A), the authentication may be requested by providing one authentication method having a low difficulty (for example, 650 in FIG. 6B). An authentication method of slightly increasing the reliability level of the user (for example, by 1) when the authentication is successful may be provided.

Meanwhile, embodiments of the present invention may provide various corresponding types of authentication methods according to degrees of a level difference between the security level of the access requested resource and the reliability level of the user.

For example, when a level difference between the security level of the access requested resource and the reliability level is 2, an authenticaiton method of increasing the reliability level by 2 may be provided.

For example, according to embodiments of the present disclosure, two authentication methods of increasing the reliability level by 1 when the authentication is successful may be provided or one authentication method of increasing the reliability level by 2 when the authentication is successful may be provided.

As described above, according to embodiments of the present invention, the authentication method may be provided in various types according to a size of the security level of the access requested resource or according to a level difference between the reliability level of the user and the security level of the access requested resource, and the user performs the authentication by the provided authentication method.

For example, when the access to the resource having the security level of level #1 is requested in a state where the reliability level of the user is level #4 (for example, when a level difference is 3), the controller 110 may make a request for the authentication by providing the plurality of authentication methods (for example, 650 and 670 in FIG. 6B) or providing one authentication method having a high difficulty (for example, 680 in FIG. 6B), and control the reliability level of the user to be increased by 3 when the authentication is successful.

According to embodiments of the present disclosure, when the authentication is not successful through the aforementioned authentication methods, the reliability level DB may be updated by decreasing the reliability level of the user, and the request for the access to the resource may be rejected.

For example, a level size of the security level decreased according to an authentication failure may be decreased by a preset size (for example, by 1), or decreased to correspond to the provided authentication method. For example, when the authentication is failed after the authentication method of increasing the reliability level by 3 when the authentication is successful is provided, the reliability level of the user may be decreased by 3 (for example, the reliability level is changed from level #2 302 in FIG. 3A to level #5 305 in FIG. 3A.

When the access to the application or data having a high security level is requested, embodiments of the present disclosure may provide a function (for example, black box system) for recording a process from an execution start to an execution end of the application or data. For example, when the authentication by the authentication method provided according to the request for the access to the resource is failed, the black box system is operated. When the authentication is successful through a re-attempt of the authentication in the future, the black box system may end.

In another example, when a state of the application or data having a high security level is changed (for example, an application is installed/removed or data is generated/deleted) or the reliability level is lowered to be equal to or smaller than a preset level (for example, an electronic device is lost), the black box system may be applied. In embodiments of the present disclosure, the black box system may be implemented through one of the camera module 150, the microphone 162, and the GPS module 157.

For example, the controller 110 according to embodiments of the present disclosure may store a situation where the application having the high security level is installed or removed as information including one of image information, voice information, and position information. At this time, the information including one of the image information, the voice information, and the position information is encrypted and stored in a security area (for example a trust zone) of the electronic device, or the user may access the information when succeeding the authentication through a preset authentication process (for example, a password or pattern lock preset by the user) in accessing the stored information.

Further, the information including one of the image information, the voice information, and the position information may be automatically transmitted to a preset server (for example, a cloud server) or a preset electronic device.

The methods according to certain embodiments of the present disclosure may be in a form of program commands executed through various computer means to be recorded in a computer readable medium. The computer readable medium may include, for example, program commands, data files, and data structures, individually or in combination. The program commands recorded in the computer readable medium may be those specifically designed for the present disclosure or well-known to and usable by a person of ordinary skill in computer software.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of using an electronic device, the method comprising:
comparing, when a request for an access to a resource of the electronic device is identified, a reliability level of a user and a security level of the resource; and
permitting the access to the resource when the reliability level is equal to or higher than the security level of the resource.

2. The method of claim 1, further comprising:
providing at least one authentication method when the reliability level is lower than the security level of the resource.

3. The method of claim 2, further comprising:
changing the reliability level according to a result of an authentication performed based on the at least one authentication method.

4. The method of claim 3, further comprising:
permitting the access to the resource when the changed reliability level is equal to or higher than the security level of the resource.

5. The method of claim 2, wherein the providing of the at least one authentication method comprises providing an authentication method corresponding to at least one of the security level of the resource, the reliability level, and a difference between the security level of the resource and the reliability level.

6. The method of claim 5, further comprising:
increasing the reliability level of the user by a difference between the reliability level of the user and the security level of the resource when the authentication by the at least one authentication method is successful.

7. A method of using an electronic device, the method comprising:
detecting a generated event of the electronic device; and
changing a reliability level of a user based on the detected event.

8. The method of claim 7, wherein the event includes an authentication event generated when the user succeeds or fails an authentication according to an authentication method provided to the user.

9. The method of claim 7, wherein the event includes a power event generated when power of the electronic device is turned on or off.

10. The method of claim 7, wherein the event includes a Subscriber Identity Module (SIM) card event generated in one of cases where a SIM card is inserted into the electronic device, the SIM card is removed from the electronic device, data of the inserted SIM card is changed, and a SIM card that does not comprise a preregistered SIM card is inserted into the electronic device.

11. The method of claim 7, wherein the event includes a position event generated in one of cases where the electronic device finds a new Access Point (AP), the electronic device accesses a new base station, and a position of the electronic device is a new position.

12. The method of claim 7, wherein the event includes a system setting event generated when a system setting of the electronic device is changed.

13. The method of claim 7, wherein the event includes a time event generated when at least one of a use time for which the electronic device is used and a standby time for which the electronic device is not used exceeds a threshold reference time.

14. The method of claim 7, wherein the event includes an external memory event generated in one of cases where data stored in an external memory is written, deleted, and moved.

15. An electronic device comprising:
at least one processor configured to drive modules;
a memory configured to store security levels of a plurality of resources including a first resource and a reliability level; and
an access control module configured to compare the reliability level and the security level of the first resource, and to determine whether to permit a request for an access to the first resource.

16. The electronic device of claim 15, further comprising:
an event detection module configured to detect an event generated in the electronic device according to the use of the electronic device; and
a reliability change module configured to change at least one reliability level stored in the memory based on the detected event.

17. The electronic device of claim 15, further comprising:
an automatic security level generation module configured to automatically determine the security levels of the plurality of resources based on permissions of the resources and to store the determined security levels in the memory.

18. The electronic device of claim 15, further comprising:
a manual security level generation module configured to determine a security level of at least one resource among the plurality of resources based on the request for the access, and to store the determined security level in the memory.

19. The electronic device of claim 16, further comprising:
an authentication providing module configured to provide at least one authentication method according to a result of a comparison between the reliability level and the security level of the first resource,
wherein the reliability change module is configured to change the reliability level according to whether an authentication by the at least one authentication method is successful.

20. The electronic device of claim 19, wherein the at least one authentication method includes at least one of a slide unlock, a password input, a pattern input, a face recognition, a fingerprint recognition, an iris recognition, biometrics, and a picture password.

21. An apparatus for using an electronic device, the apparatus comprising:
a controller configured to control to compare, when a request for an access to a resource of the electronic device is identified, a reliability level of a user and a security level of the resource, and to permit the access to the resource when the reliability level is equal to or higher than the security level of the resource.

22. The apparatus of claim 21, wherein the controller provides at least one authentication method when the reliability level is lower than the security level of the resource.

23. The apparatus of claim 22, wherein the controller controls to change the reliability level according to a result of an authentication performed by the at least one authentication method.

24. The apparatus of claim 23, wherein the controller controls to permit the access to the resource when the changed reliability level is equal to or higher than the security level of the resource.

25. The apparatus of claim 22, wherein, when the controller provides the at least one authentication method, the controller controls to provide an authentication method corresponding to at least one of the security level of the resource, the reliability level, and a difference between the security level of the resource and the reliability level.

26. The apparatus of claim 25, wherein, when the authentication of the at least one authentication method is successful, the controller controls to increase the reliability level of the user by a difference between the reliability level of the user and the security level of the resource.

27. An apparatus for using an electronic device, the apparatus comprising:
a controller configured to control to detect a generated event of the electronic device and to change a reliability of a user level based on the detected event.

28. The apparatus of claim 27, wherein the event includes an authentication event generated when the user succeeds or fails an authentication according to an authentication method provided to the user.

29. The apparatus of claim 27, wherein the event includes a power event generated when power of the electronic device is turned on or off.

30. The apparatus of claim 27, wherein the event includes a Subscriber Identity Module (SIM) card event generated in one of cases where a SIM card is inserted into the electronic device, the SIM card is removed from the electronic device, data of the inserted SIM card is changed, and a SIM card not comprising a preregistered SIM card is inserted into the electronic device.

31. The apparatus of claim 27, wherein the event includes a position event generated in one of cases where the electronic device finds a new Access Point (AP), the electronic device accesses a new base station, and a position of the electronic device is a new position.

32. The apparatus of claim 27, wherein the event includes a system setting event generated when a system setting of the electronic device is changed.

33. The apparatus of claim 27, wherein the event includes a time event generated when at least one of a use time for which the electronic device is used and a standby time for which the electronic device is not used exceeds a threshold reference time.

34. The apparatus of claim 27, wherein the event includes an external memory event generated in one of cases where data stored in an external memory is written, deleted, and moved.
